(19) United States
(12) Patent Application Publication
(10) Pub. No.: US 2010/0141766 A1
(43) Pub. Date: Jun. 10, 2010

(54) SENSING SCANNING SYSTEM

(75) Inventors: Tomislav F. Milinusic, Edmonton (CA); Jory Krogsgaard, Leduc (CA); Sarbjit Singh Johal, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignees: Panvion Technology Corp., Edmonton (CA); Sky Innovations, Inc., Warrenton, VA (US)

(21) Appl. No.: 12/330,458

(22) Filed: Dec. 8, 2008

(51) Int. Cl. H04N 7/18

(52) U.S. Cl. 348/159; 348/E07.085

(57) ABSTRACT

A method of securing and extracting sequential sensor data includes scanning a volume with at least one electromagnetic sensor to obtain multiple scans. Each scan has at least one different characteristic to create a multiple scan sequence of the volume. At least one volume subset is extracted from the multiple scan sequence containing at least one event satisfying at least one predetermined criterion. The at least one volume subset is analyzed to classify the at least one event using predetermined characteristics. A sensing scanning system for carrying out the method includes a scanner with at least one electromagnetic sensors, and a processor connected to receive the scans from the scanner

### FIELD

A scanning system for the collection, analysis and distribution of remotely sensed data related to an event from both static and moving platforms.

### BACKGROUND

Collecting, analyzing and extracting remotely sensed data by digital means has been done for decades as is demonstrated by the substantial collection of satellite imagery, scientific and military use of radars, and the monitoring of weather conditions. See, for example, U.S. Pat. No. 7,106,333 (Milinusic) entitled “Surveillance System”, and U.S. Pat. No. 6,989,745 (Milinusic et al.) entitled “Sensor Device for Use in Surveillance System”.

There exists a need to extract specific features, events, or characteristics of motion present in objects within a substantially large volume. Examples include detection of targets such as moving vehicles from 65,000 ft high-flying surveillance UAV, or vehicles and individuals from the surveillance coverage of a large panoramic border area or cityscape. In each case, from a static or moving platform thousands of targets, events, or specific features are required to be extracted effectively and efficiently from the large volume of data.

### SUMMARY

According to an aspect, there is provided a method of securing and extracting sequential sensor data, comprising the steps of: scanning a volume with at least one electromagnetic sensor to obtain multiple scans, each scan having at least one different characteristic to create a multiple scan sequence of the volume; extracting at least one volume subset from the multiple scan sequence containing at least one event satisfying at least one predetermined criterion; and analyzing the at least one volume subset to classify the at least one event using predetermined characteristics.

According to an aspect, there is provided a sensing scanning system comprising a scanner comprising at least one electromagnetic sensors. The scanner is programmed to obtain multiple scans of a volume using the at least one electromagnetic sensor. Each scan has at least one different characteristic. A processor is connected to receive the scans from the scanner. The processor is programmed to compare the multiple scans from the scanner to identify events based on a change between the scans satisfying at least one predetermined criterion; extract a volume subset from the scans containing each event; and analyze at least a portion of the volume subset to characterize each event using predetermined characteristics.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a block diagram of a sensing scanning system.

FIG. 2 is a block diagram of a sensing scanning system with a user interface.

FIG. 3 is a block diagram depicting the scanning sequence.

FIG. 4 is a block diagram of a sensing scanning system with a secondary system.

FIG. 5 is an alternate block diagram of a sensing scanning system with a secondary system.

FIG. 6 is an alternate block diagram of a sensing scanning system.

### DETAILED DESCRIPTION

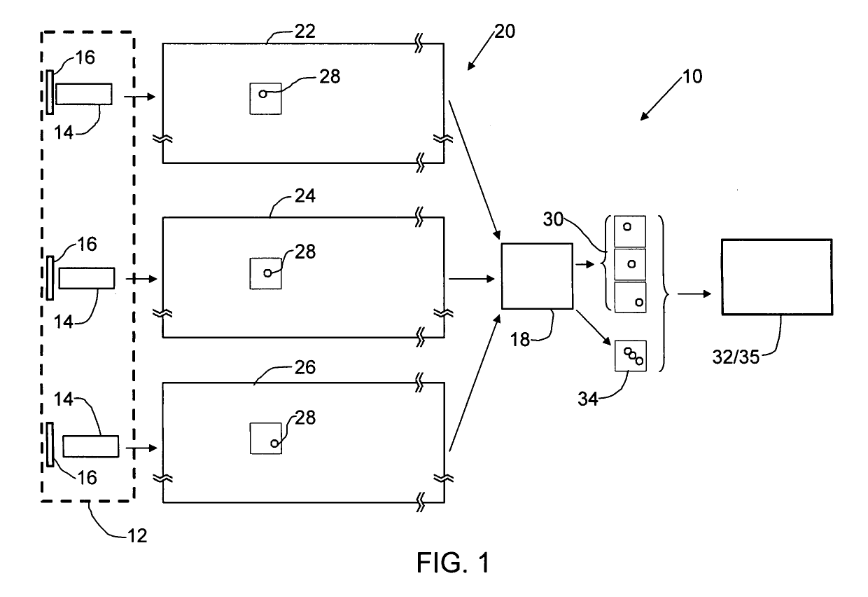

A sensing scanning system generally identified by reference numeral 10 will now be described with reference to FIG. 1 through 6.

### Structure and Relationship of Parts:

Referring to FIG. 1, sensing scanning system 10 includes a scanner 12 with electromagnetic sensors 14. Scanner 12 may have one or more electromagnetic sensors 14. Scanner 12 is programmed to obtain multiple scans of a volume using electromagnetic sensors 14 to obtain scans having different characteristics.

In different embodiments, scanner 12 may have a single sensor 14 with a series of modifiers 16 for changing the characteristics of the successive scans, or multiple sensors 12 with a series of modifiers 16. Alternatively, each sensor 14 may be selected for a specific inherent or permanent modifier, where the desired characteristics determine the types of sensors that are selected. Different characteristics that may be used include a difference in space, time, electromagnetic polarization, electromagnetic phase, electromagnetic amplitude, and electromagnetic wavelength. Modifiers may include various types of filters, such as polarizers, phase shifters, or spectral filters.

In some embodiments, sensing scanning system 10 may be used for observation of a volume or area, such as for security purposes. Scanner 12 may be mounted on stationary platform or a moving platform for observing the volume. If a moving platform is used, a stabilization device or algorithm is preferably used to improve the quality of the scans and provide accurate geo-referencing. The various ways in which the teachings contained herein may be used will be recognized by those skilled in the art, and may include uses such as surveillance, search and rescue, situation awareness, ground characterization, etc. In these embodiments, sensing scanning system 10 may be referred to as a remote sensing scanning system. However, other embodiments may not be remote. Sensing scanning system 10 is preferably designed to provide a user with the ability to identify possible events of interest that may be very numerous or very small relative to the size of the volume. Thus, sensing scanning system 10 may be used to obtain information of any type of volume that is able to be scanned whether at long range or at microscope scales.

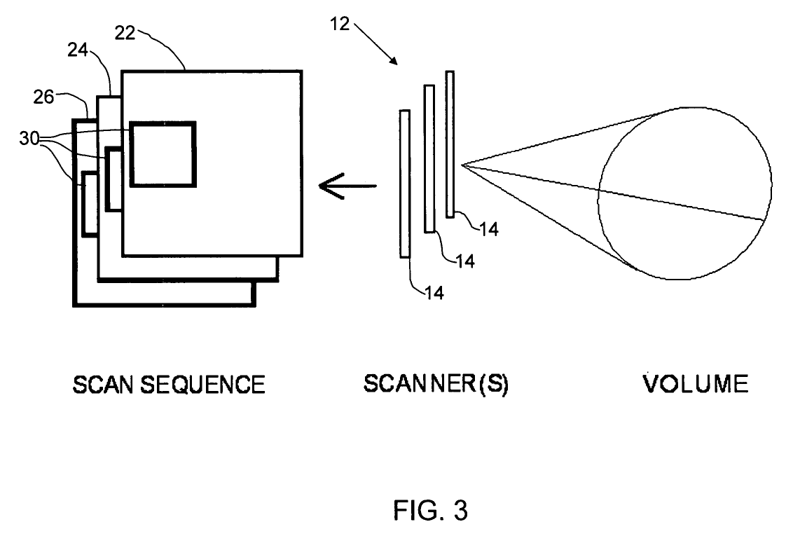

Sensing scanning system 10 also includes a processor 18 that is connected to receive the scans from scanner 12. Processor 18 is programmed to compare the multiple scans received from scanner 12 to identify events. Referring to FIG. 3, a multiple scan sequence 20 obtained by sensors 14 of scanner 12 is shown having three scan 22, 24 and 26. Referring to FIG. 1, an “event” is indicated by reference numeral 28. Events 28 are based on a change between scans 22, 24, 26 that satisfy at least one predetermined criterion programmed into processor 18, and are generally detected by a difference in, for example, the luminance or amplitude of a pixel in an optical embodiment, or phase and polarimetric angles in a radio signal between the different scans. For example, if the difference between the scans is time, the predetermined criteria may relate to the movement of an object having a specified shape, color, size, etc. If the difference is the electromagnetic radiation detected, the predetermined criteria may relate to a particular band of radiation being absorbed, emitted or reflected. Combinations of these various criteria and differences may also be used to help identify events of interest. Using both motion detection as well as Multispectral differentiation increases the chance to narrow the detection of an event meeting very specific characteristics. For example, this could be the case of locating and tracking the smoke from certain types of fires based on their motion against the sky and their spectral signature, thus differentiating smoke from rubber tires versus industrial or forest fires. In the depicted example, the movement of a round object is the event that is detected.

Referring to FIG. 1, once event of interest 28 has been detected, processor 18 extracts a volume subset 30 from scans 22, 24, 26 containing event 28. Generally, a volume subset 30 is extracted for each event 28. Volume subset 30 is then analyzed by processor 18 to characterize or classify event 28 using predetermined characteristics. Only a portion of volume subset 30 may be analyzed, for example, the analysis may include only event 28.

The particular type of analysis performed will depend on the preferences of the user. Analysis of volume subset 30 and event 28 may include categorizing the event according to predetermined characteristics. These may be based on, for example, angular, geographic, color, speed, size, polarization, and other measures derived from the differences between the scans and the modifiers or inherent capabilities of the scans. As volume subset 30 includes a portion of each scan 22, 24, 26, analysis may include creating a descriptor 34 that describes event 18 through processing the portions. For example, an algorithm, such as a subtraction algorithm, may be used to remove or reduce the background that is common to the entire volume subset 30 in order to emphasize the event that occurred. This would then be stored in a database 32 (if present) along with volume sub-set or “snippet”, a term used to describe a sequence of the sub-volume. In another embodiment, where time is a difference between the scans, the volume subset 30 may in a format that allows it to be replayed as a video sequence showing the time progression of the event.

The analyzed subset may then be transmitted to a database 32 from processor 18 to be stored. While database 32 is shown and described, it will be understood that it may not be necessary. For example, the analyzed volume may be transmitted directly to a user interface 35, where it is dealt with directly by a user. In addition to its storage function, database 32 may also include processing capabilities to either obtain additional information from the volume subset, or to analyze large numbers of analyzed subsets to look for trends, patterns, etc.

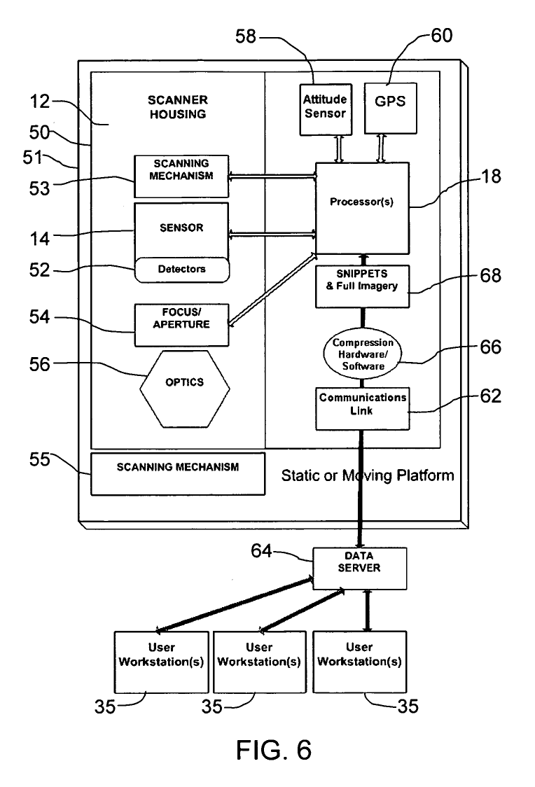

While processor 18 is shown as being a separate element in FIG. 1, it will be understood that the processing steps may be divided up among many processor components. For example, referring to FIG. 6, processor 18 may be housed within a scanner housing 50 as shown, or included in scanner 12 to give it the processing capability to compare the scans, identifying events, extracting volume subsets, and transmit the volume subsets to database 32, which would then have the processing capability to analyze the volume subset and the events they contain.

In some embodiments, scanner 12 operates multiple sensors 14 simultaneously, or in parallel, to obtain the scans, while the processor extracts the volume subsets during the scanning process. In other words, processor 18 may extract volume subsets prior to the scans being completed. For example, if the difference were a difference in time, each sensor 14 would start scanning prior to the other sensors 14 completing their scan. This allows a user to increase the time difference between the scans, which results in detecting slower moving or slower occurring events relative to the actual scan rate's time scale.

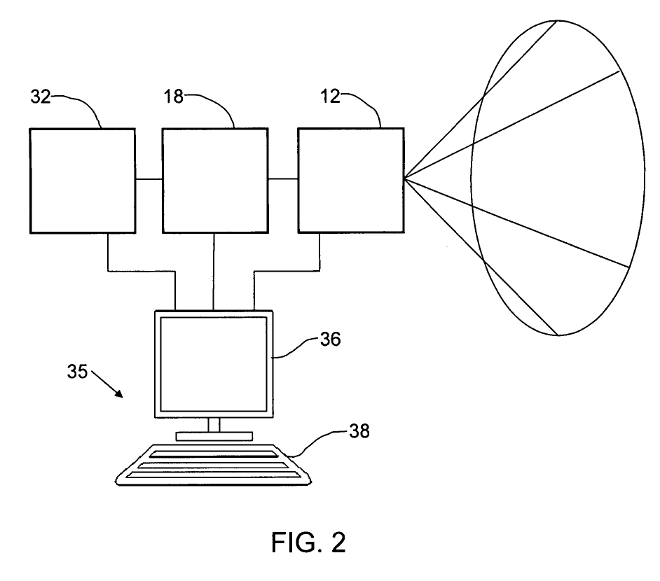

In some embodiments, referring to FIG. 2, a display 36 may be connected to database 32 and/or processor 18, as the case may be. Display 36 is useful to draw a user's attention to a volume subset 30, and to facilitate interaction with the rest of system 10. If display 36 is connected after event 28 and subset 30 have been analyzed and classified, the user may use an input device 38, such as a computer keyboard, mouse, or data port for downloading new instructions or adjusting the existing instructions, to limit what is displayed by selecting certain characteristics. For example, a user may select to view only objects having certain characteristics travelling at a certain speed in a certain direction, or if thermal imaging is used, objects of a certain temperature.

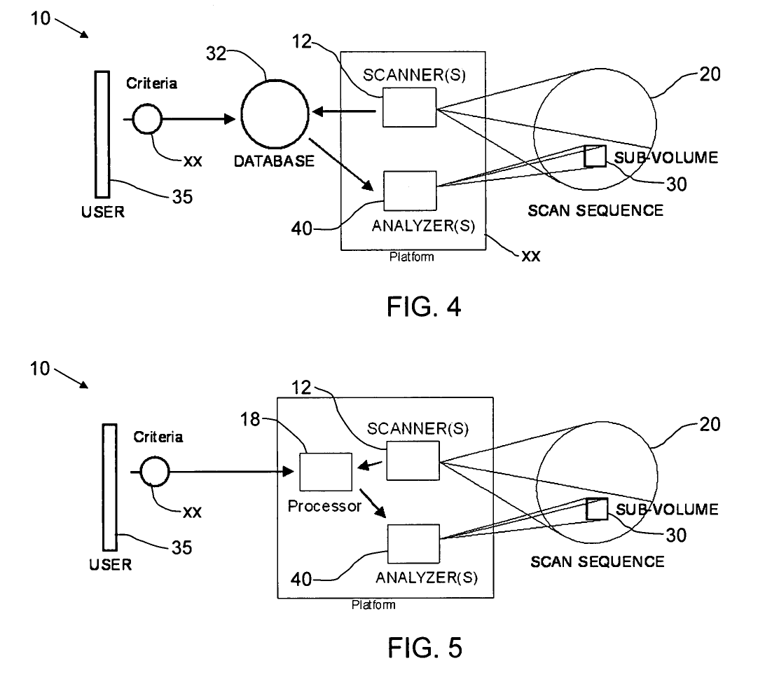

In some embodiments, the user may also use input device 38, which would be connected to database 32, processor 18, and scanner 12, as the case may be, to modify various parameters in system 10. Some examples include the characteristics of the scans obtained by scanner 12, the number or frequency of scans, the resolution of the scans, the predetermined criteria for identifying events, and the predetermined characteristics used to classify or characterize each event by the processor. Input device 38 may also be used to select an event stored in the database or displayed on display 36. This may be done either to obtain more information that is stored in the database, to instruct a processor to process it further to obtain more information, or, referring to FIGS. 4 and 5, to instruct an auxiliary device 40, which may be referred to as an analyzer, to obtain more information on the event, such as by scanning. This may be done directly, or through database 32. Auxiliary device 40 may be one or more geographically dispersed sensors that detect a higher resolution or different characteristic, or it may be one or more tracking devices, such as a camera, that is able to follow the movement of an event. As the auxiliary device 40 will generally have a narrower field of view to obtain a higher resolution, the orientation of auxiliary device 40 is preferably controlled to be able to redirect it toward the desired event either automatically, or interactively by the user.

In another embodiment, the event may be analyzed to characterize it using projective geometry, or orthorectification, based on a digital terrain model of the area in the field of regard of the scanner and on the three dimensional location and attitude comprising of three angles (roll, pitch, yaw) of the principal optical axis of the scanner. For an object in motion, this allows the speed, acceleration, heading, location, and size of the object in motion to be precisely determined. This information may then be plotted on a display to provide better information to a user. Preferably, this would be done once the information has been stored in a database by a processor associated with the database. However, it may be done by any suitable processor. In the case of a scanner on moving platform such as a UAV, the precise timing of the acquisition of each pixel is needed so that an estimate of the 3 dimensional location of the aircraft is known as well as all the elements relating to the attitude of the principal optical axis of the scanner. This information provides through projective geometry or photogrammetric methods a registration of each pixel on the digital elevation model or virtual digital terrain model. Out of the precise location of two or more consecutive snippets it is possible to obtain information relative to speed, heading, acceleration, size both height width and length of a moving object, as well as range and all three geo-location parameters, namely: latitude, longitude and altitude. This is more than what a traditional radar is able to achieve, hence the name of an Optical Ground Motion Target Indicator is appropriate for this invention.

It will be understood that, generally, the scans obtained by scanner 12 are not required to be stored once the volume subset has been extracted. However, in some circumstances it may be desirable to periodically retain a scan. This may be done to update background information that may change over time, or also to compare scans at a later date to detect changes over time that may not be rapid enough to be detected by successive scans in a scan sequence.

Example of an Optical System

An example of an optical system will now be described that may be employed that covers the visible up to the far infrared regions of the spectrum (400 nm to 12 microns). This may be for ground based surveillance, or an airborne Optical Ground Motion Target Indicator (OGMTI) surveillance system. Other possible uses include a multi-spectral scanner for the detection of sea-going vessels, the detection of smoke from a fire, or similar concepts applied to other regions of the electromagnetic spectrum including infra-sound, radar and even x-ray. The system may also use a combination of these uses.

Referring to FIGS. 4 and 5, the system's general architecture preferably uses a close coupling between the scanning system that preferably, but not necessarily, has a wide field of regard, and a secondary system, such as one or more analyzers 40. The role of the scanning system is the detection, extraction and analysis of an event for onwards transmission to the secondary system 40, and includes scanner 12, processor 18, database 32 and/or user interface 35. The secondary system, or analyzer 40, receives the transmission either directly, or through database 32 as shown in FIG. 4 or processor as shown in FIG. 5. The analyzer 40 has one or more electromagnetic sensors that have a narrower field of regards than the scanner 12, and provides a detailed analysis and tracking of the event in subvolume 30. It is controlled by cues provided by the scanning system. At the heart of this process is the output from the scanning system which consists of volume subsets, which may also be referred to as sub-scenes, sub-sets of data, or snippets, from the main data acquired by scanner 12. After scanner 12 has analyzed a plurality these output snippets, they may be stored in a database 32, used to trigger on user demand or on pre-defined conditions tracking and pointing cues to assist the narrower field of view analyzer system 40 to further documents the sub-volume of interest, or both.

An embodiment of the Optical Ground Motion Target Indicator (OGMTI), based scanner surveillance system may have the following features. The principal embodiment of a daylight scanner uses tri-linear array of pixels to achieve a real-time Optical Ground Motion Target detection. One strategy that may be used to have a complete sequence of scanned images is instantaneous detection of motion while scanning occurs. This may then be compared for change between the sequence of images. To provide a panoramic 360 degree total configured scan, multiple scanners, e.g. four, may be provided. In this example, each scanner provides a 90 degree segment of the field of regard. In another embodiment, four scanners may be employed that use only two sets of linear arrays to cover 360 degrees instead of four, due to the geometric construct. The typical vertical scan is on the order of 30 degrees, but may be adjusted depending on user preferences. For example, if the scanner provides a 90 degree vertical scan, hemispherical coverage may be provided. The output from the OGMTI may be derived in real-time or at a later time from the tri-linear scan.

Snippets are created, and multiple variables are extracted, such as eleven or more, that are related to the targets based on, for example, angular, geographic, size, speed, polarization, color, and other measures derived from imagery, time and spectral differentiating sources. The snippets are then transferred or transmitted to a database or to a processor for the analyzer system, with or without filtering of target data. Other features may include:
Geo-location calculations derived from snippets and other sensors
Complete server client architecture for the surveillance system
Algorithms for stabilization, mosaicing and geo-location of data unique to the system
Scanning and cueing of target may be made within or without the same system using Analyzer
Use of multi-spectral differentiation in the analyzer section
Use of folded mirror optical path for the analyzer and for scanner
Simultaneous infrared and night vision step-stare scanning and its fusion into the architecture
Simultaneous use of daylight scanning and analyzer with tracking capabilities independent of the analyzer
Filtering ability to display snippets and extraction of historic data based on geo-location and characteristic parameters.

1. Scanner

In a preferred embodiment, the scanner surveillance system has a hardware portion, a software portion, and a conceptual portion. In the discussion below, the embodiment is of a scanner used for volumetric or geographical scanning. It will be understood that if the scanner is used in other fields, the examples given may be modified to suit the specific purpose.

1(a). Hardware Platform

Referring to FIG. 6, the hardware platform 51 has a static or moveable platform that supports one or more linear or focal plane array sensors 14 operating in a defined region of the electromagnetic spectrum, such as the ultraviolet to the far-infrared region. These sensors contain a multiple active sensing elements 52 such as CCD, CMOS, image intensified or infrared detectors. There are focal plane image forming optical elements 54 and 56, such as a lens or catadioptric mirror that are configured for the specific electromagnetic wavelength region that is employed. A scanning mechanism 53 is used to translate the sensors across the focal plane image formed by the lens or to translate the focal plane across the sensors 1 so that collectively an image is formed. This scanning mechanism may be made up of one or more mirrors, rotating or linear mechanical stages, or combinations thereof. The scanning mechanism 53 may be placed before the lens 56 or attached to the sensor 14, depending on the mechanism. To control the focus of the image produced by the lens 56 and its aperture 54, mechanisms that may be electrical, electro-optical or optical in nature may be used.

The scanning mechanism itself may be scanned by a second scanning mechanism 55 whose purpose is to provide a plurality of scans that cover a given field of view up to a panoramic 360 coverage. Both scanning mechanisms 53 and 55 can be used to direct the focal plane image to a specific field of view location both azimuthally and vertically so that a complete hemispherical coverage is possible.

One or more processors 18 are used to controls and interacts with the scanning mechanisms 53 and 55 in terms of, for example, the speed of the scan, the limits of scan coverage, the start and end of scan both horizontally and vertically (azimuthally), and the pattern of scan (variable, fixed, reverse, etc.). Other features may also be used as recognized by those skilled in the art, depending on the circumstances. The processor 18 may also control and interact with the acquisition of sensor imagery data produced by the sensors 14 in terms of the rate of data acquisition from the sensor, and automatic and/or manual control of parameters related to the sensor such as contrast, brightness, gain, etc. The processor 18 may also be used to control and interact with the focus and aperture 54 of the lens 56 through automatic software algorithms or manual adjustments. The processor 18 preferably controls communication through a communication link 62 that may be, for example, wireless, IP based, LAN, fiber optics or other electronic means to dispatch data. Depending on the preferences of the user and the specific application, the transmitted data may include, for example, data streams 68 produced by the sensor(s) to a receiving data server 64 for storage, archival and/or further processing, data from the attitude determination sensor 58 and GPS sensor 60, or data including the entire raw or compressed pixel data taken by the scanning system to the Data Server 64.

With respect to the OGMTI, the processor 18 preferably performs OGMTI detection on two or more images acquired at different times through image processing algorithms. The processor 18 would then note rectangular or irregular shaped areas, known as snippets that correspond to the detected images, and transmit them using the communications link 62 as described above. In addition, the processor 18 may create or define the parameters that are relevant to the motion, including, for example, (1) dimensions of the moving object (width, height length, or other size and shape measurement), (2) geographic location of the moving object (latitude, longitude and altitude above sea level for example), (3) measurements of speed and acceleration of moving object between each consecutive and intra-image and combination thereof, (4) heading vector (azimuth and dip angles, etc.) of the object between each consecutive and intra-image and combination thereof, (5) other derived measures such as slant angle to moving object from the sensor, slant and ground range and other derived measures, and/or (6) measurement of derived pixel luminance across the operational electromagnetic spectrum in one or more spectral bands. Optionally, one or more data servers 64 may also be provided that store data, and optionally perform some or all of the functionalities described for the processor 18 above. The data servers 64 are primarily used to act as the distribution point of the data through IP or other protocols or mediums to be shared by any number of user workstations 35 anywhere in the world, if this feature is present. Processor 18 or data server 64 may include a compression hardware chip 66, which may also be an independent component or present as a software compression algorithm whose function is to compress data in order to transmit the data efficiently to or from the data server 64.

It will be understood that, in some embodiments, the processing undertaken by the processor 18 can also be architecturally configured to be done using the processing power of the data server 64.

The data that is processed by the processor and/or User Workstation(s) 35 that request and extract data from the Data Server 64 and can through the Data Server 64 control the parameters associated with the scanner's operations, filtering and requesting specific data from the scanner 12 or the data server 64, and/or a communications link 62 that connects the processor 18 with the data server 64, and data server 64 with workstations 35.

The hardware portion of the scanner may also include devices to improve calculations of the position of an event. This may include, for example, a tri-axis gyroscope, two axis dip meters, or optical flow methods or other means that provides information to determine the instantaneous attitude of the sensor unit in order to correct rotation in any axis of the scanner and by geometric means that could include a digital elevation model determine the geo-location of the target. This may also include a GPS sensor 60 to assist in precise timing and geo-location calculations.

Preferably, a protective scanner housing 50 and associated enclosures, either hermetically sealed or otherwise, is provided to protect the various hardware components described above.

1b. Software Portion

In the geographic application used as an example herein, the software portion of a scanner surveillance system preferably includes software to extract moving objects from two or more images acquired at different time intervals. The algorithms for such software can be any one of the many available including those that use simple differencing, those that use texturing, those that use Multispectral means, etc. At a high level, the software portion may also be designed to perform the following functions:
create OGMTI variables from the snippet imagery;
determine the geo-location of the mover;
ortho-rectify the moving object location and other parameters of OGMTI through the use of a stored digital elevation model;
control the sensor parameters and image quality;
control the aperture and focus;
receive the GPS and attitude sensor data;
ensure that sensor is not damaged by illumination of sun or its reflections on water and other objects;
create a virtual Command and Control based on 3-D model of area under surveillance including digital elevation model data;
determine scan patterns;
control communications with Data Server;
diagnostic software for the entire system; and
accessing storage data on the storage medium;

1c. Conceptual Portion

The conceptual portion of a scanner surveillance system is defined to help in the design of the hardware and software portions discussed above. Features of the conceptual portion may include one or more of the following functions:
mechanical movements to scan sensor across field of view in any direction and scan rate;
extraction of areas of motion from images created from consecutive scans;
continuous compression and or streaming of the sub-images to a processor or Data Server with and without OGMTI decoded information derived from the extracted areas of motion;
external geo-location and attitude information of platform to assist in determining OGMTI geo-location, speed and other parameters using digital elevation models and orthorectification;
user or user configured filtering and initiated extraction of data from data server; and
display of data form data server using 3D model of area and symbols.

In addition to the features described above, an embodiment of a surveillance system may also include the ability to simultaneously achieve visible, “night vision image intensified and infrared scanning”, and narrow field analysis in those same bands at the same time using appropriate sensors for the task. There may also be a multi-spectral camera addition to the sensors, and a spectrometer to record the spectrum of a target as seen by the analyzer. The spectral information may then be used to positively identify the same target in a cluttered targets environment. Finally, while the surveillance system as described is primarily a passive sensor, there may also be provided a mechanism for illuminating the target, such as by laser or other means, including gated imaging concepts, in order to obtain better imagery, such as the case in image intensified imagery.

### Advantages:

The system as describe above permits scanning of wide-volumes effectively at the required high resolution. This has traditionally been very difficult to achieve, as the wider the field of regards, the poorer is the resolution for a given sensor. The system can be designed to handle a large number of discrete events that occur, such as thousands or more, and quantify their inherent parameters in a geographic and/or volumetric context. The data can then be dispatched to a database, or it can be processed in real-time at the sensor head. Those events can then be filtered to focus on a few for increased scrutiny and analysis. These filtered events are tracked and higher information content of those events are provided for further action in a geographic or volumetric context.

With these capabilities, it is possible to offer a comprehensive real-time or at a later time situation awareness of a volume of space previously unattainable benefiting a number of applications including surveillance from the air and ground of large volume space.

### Variations:

While the scanner above is described primarily in the volumetric and geographic context, it will be understood that many different situations. For example, it may be used to analyze a small area or volume where a very high resolution is required. Events would be identified, and processed as described above.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method of securing and extracting sequential sensor data, comprising:
scanning a volume with at least one electromagnetic sensor to obtain multiple scans, each scan having at least one different characteristic to create a multiple scan sequence of the volume;
extracting at least one volume subset from the multiple scan sequence containing at least one event satisfying at least one predetermined criterion; and
analyzing at least a portion of the at least one volume subset to characterize the at least one event using predetermined characteristics.

2. The method of claim 1, wherein the at least one volume subset is extracted prior to each of the scans being completed.

3. The method of claim 1, wherein the at least one electromagnetic sensor is mounted on one of a moving platform and a stationary platform.

4. The method of claim 1, wherein the multiple scans are obtained through the use of a single sensor with a series of modifiers being used to change the characteristics of multiple scans by the single sensor.

5. The method of claim 1, wherein the multiple scans are obtained through the use of multiple sensors with a series of modifiers being used to change the characteristics of multiple scans by the multiple sensors.

6. The method of claim 1, wherein the multiple scans are obtained through the use of multiple sensors, the multiple sensors operating simultaneously to scan the volume.

7. The method of claim 1, wherein the at least one different characteristic comprises a difference in at least one of space, time, electromagnetic polarization, electromagnetic phase, electromagnetic amplitude, and electromagnetic wavelength.

8. The method of claim 1, wherein the at least one predetermined criterion comprises a difference in at least one of luminance, amplitude, phase, and polarization angle of an electromagnetic signal between scans in the multiple scan sequence.

9. The method of claim 1, wherein the at least one predetermined criterion comprises a similarity in at least one of luminance, amplitude, phase, and polarization angle of an electromagnetic signal between scans in the multiple scan sequence.

10. The method of claim 1, wherein the volume subset comprises a portion of each scan in the multiple scan sequence, and wherein analyzing the volume subset comprises processing the portions of the more than one scans to form a descriptor describing the event.

11. The method of claim 1, wherein the volume subset comprises a portion of each scan in the multiple scan sequence, the volume subset depicting a change over time.

12. The method of claim 1, further comprising the step of storing the analyzed volume subset in a database.

13. The method of claim 1, further comprising the step of displaying the volume subset on a display.

14. The method of claim 1, further comprising the step of changing at least one of:
the at least one different characteristic of the scans obtained by the scanner,
the number of scans obtained by the scanner;
the at least one predetermined criterion in the processor; and
the predetermined characteristics used to characterize each event.

15. The method of claim 1, further comprising the step of storing scans at a predetermined frequency

16. The method of claim 15, further comprising the steps of forming a delayed multiple scan sequence from the stored scans and extracting at least one volume subset from the delayed multiple scan sequence containing at least one event satisfying at least one predetermined criterion.

17. The method of claim 1, further comprising the steps of identifying an event of interest, and obtaining additional information on the event using a secondary scanner.

18. The method of claim 1, wherein scanning a volume comprises scanning the volume with more than one of infrared sensors, daylight sensors, and night vision sensors operating simultaneously.

19. The method of claim 1, wherein analyzing the at least a portion of the at least one volume subset comprises characterizing the event using projective geometry based on a digital terrain model and geolocation and attitude information of the scanner and its principal optical axis field of regard.

20. The method of claim 19, wherein the event is an object in motion, and the event is characterized to determine at least one of the speed, acceleration, heading, location, range, and size parameters of the object in motion.

21. The method of claim 1, further comprising the steps of:
selecting an event; and
instructing a secondary system to obtain additional information of the event.

22. A sensing scanning system, comprising:
a scanner comprising at least one electromagnetic sensors, the scanner being programmed to obtain multiple scans of a volume using the at least one electromagnetic sensor, each scan having at least one different characteristic;
a processor connected to receive the scans from the scanner, the processor being programmed to:
compare the multiple scans from the scanner to identify events satisfying at least one predetermined criterion;
extract a volume subset from the scans containing each event; and
analyze the volume subsets to classify each event using predetermined characteristics.

23. The sensing scanning system of claim 22, wherein the processor extracts the volume subsets prior to each of the scans being completed.

24. The sensing scanning system of claim 22, wherein the scanner comprises a single sensor with a series of modifiers for changing the characteristics of the scans.

25. The sensing scanning system of claim 22, wherein the scanner comprises multiple sensors with a series of modifiers for changing the characteristics of the scans.

26. The sensing scanning system of claim 22, wherein the scanner comprises more than one electromagnetic sensor, the scanner being programmed to scan the volume with the electromagnetic sensors operating simultaneously.

27. The sensing scanning system of claim 22, wherein the at least one different characteristic comprises a difference in at least one of space, time, electromagnetic polarization, electromagnetic phase, electromagnetic amplitude, and electromagnetic wavelength.

28. The sensing scanning system of claim 22, wherein the predetermined criteria comprises a difference in the relative amplitude of pixels between scans in the multiple scan sequence.

29. The sensing scanning system of claim 22, wherein the volume subset comprises a portion of each scan in the multiple scan sequence, and wherein analyzing the volume subset comprises processing the portions of the more than one scans to form a descriptor describing the event.

30. The sensing scanning system of claim 22, wherein the volume subset comprises a portion of each scan in the multiple scan sequence, the volume subset depicting a change over time.

31. The sensing scanning system of claim 22, further comprising a database connected to receive the analyzed volume subset from the processor for storing the analyzed volume subset.

32. The sensing scanning system of claim 22, wherein the processor comprises more than one processor connected to transfer data between the more than one processors.

33. The sensing scanning system of claim 22, further comprising a display connected directly or indirectly to the processor for displaying the volume subset.

34. The sensing scanning system of claim 22, further comprising an input device connected directly or indirectly to the processor, and the scanner for modifying at least one of:
the at least one different characteristic of the scans obtained by the scanner,
the number of scans obtained by the scanner;
the at least one predetermined criterion in the processor; and
the predetermined characteristics used to classify each event by the processor.

35. The sensing scanning system of claim 22, further comprising:
an input device connected to one of a database or the processor for selecting an event;
a secondary scanner connected to the input device for obtaining additional information on the selected event.

36. The sensing scanning system of claim 22, wherein the scanner is mounted on one of a moving platform or a stationary platform.

37. The sensing scanning system of claim 22, wherein the scanner is mounted on a moving platform using a stabilization device.

38. The sensing scanning system of claim 22, wherein scans are stored in a database at a predetermined frequency.

39. The sensing scanning system of claim 38, further comprising a processor connected to the database, the processor being programmed to compare the stored scans to identify events satisfying at least one predetermined criterion, and to extract a volume subset from the scans containing each event.

40. The sensing scanning system of claim 22, wherein the processor is further programmed to characterize the event using projective geometry based on a digital terrain model and geolocation and attitude information of the scanner and its principal optical axis field of regard.

41. The sensing scanning system of claim 40, wherein the event is an object in motion, and the event is characterized to determine at least one of the speed, acceleration, heading, location, range and size parameters of the object in motion.
